(19) United States
(12) Patent Application Publication
(10) Pub. No.: US 2024/0369193 A1
(43) Pub. Date: Nov. 7, 2024

(54) VERY LOW PROFILE AND HIGH LIGHT OUTPUT LED LIGHT FIXTURE

(71) Applicants: Joel Gross, Brooklyn, NY (US); Jingbo Chen, Oakland Gardens, NY (US); John Luk, Flushing, NY (US)

(72) Inventors: Joel Gross, Brooklyn, NY (US); Jingbo Chen, Oakland Gardens, NY (US); John Luk, Flushing, NY (US)

(73) Assignee: Lighting & Supplies, Inc., Brooklyn, NY (US)

(21) Appl. No.: 18/438,812

(22) Filed: Feb. 12, 2024

Related U.S. Application Data
(60) Provisional application No. 63/446,922, filed on Feb. 20, 2023.

(51) Int. Cl. F21K 9/238; F21S 8/00; F21S 8/02; F21V 3/04; F21V 21/04; F21V 23/00; F21V 23/06; F21V 29/70; F21Y 105/10; F21Y 115/10

(52) U.S. Cl. CPC F21K 9/238; F21S 8/026; F21S 8/03; F21V 3/049; F21V 21/047; F21V 23/005; F21V 23/06; F21V 29/70; F21Y 2105/10; F21Y 2115/10

(57) ABSTRACT

A very low profile and high light output LED light fixture is disclosed for recessed down light can retrofits and as new LED light fixture mountable to junction boxes for ceiling or wall installations, or as a dual-purpose LED light fixture consisting of a combination heat sink and integral flat flange ring unitary main die-cast housing for the attachment of at least one LED array mounted to a circuit board or a COB LED or AC dob LED module, further including at least two mounting supports for optional removable springs or clips, a pair of junction box mounting clearance holes for screws, an internal dimmable LED driver or AC driver-on-board, optional interchangeable decorative trim covers, an optional medium screw base male plug adapter, and a protective diffusion lens cover installed to the front of the LED light fixture.

### FIELD OF THE INVENTION

The present invention relates generally to a low-profile LED lighting fixture with an efficient high light output that can be used in a recessed retrofit down light can application and for direct mounting to a junction box in new or existing ceiling and wall installations.

### BACKGROUND OF THE INVENTION

Incandescent tungsten filament lamps were the first source of light that was created. These incandescent lamps were later used on dimmers that controlled the amount of current going into the lamps to provide dimming of the light output and for energy savings. HID High Intensity Discharge or MH Metal Halide lamps and fluorescent lamps were later discovered that offered increased lamp life and brighter outputs over the incandescent lamps. These HID or fluorescent lamps operated with a ballast that first ignited an arc and then limited the power to the lamp to keep the arc operating. Certain HID or fluorescent lamps could be used with special dimming ballasts that could be dimmed for additional energy savings.

Advancements in LED brightness and efficacy have allowed LED lamps and LED fixtures to be developed that could offer even longer lamp life and brighter light outputs when properly configured, to compete with HID or fluorescent lamps. An LED driver is used to provide the correct power to the LEDs either through PWM, constant voltage, or constant current. The LED lamps and LED fixtures can be hard-wired directly to the driver in an internal or external configuration, or the driver can be eliminated with the use of dimmable AC driver-on-board or AC dob LED light fixtures using IC controller chips. The LED drivers can be made dimmable for use with the already inherent energy saving nature provided by the LEDs.

For new designs and ease of retrofits, it is desirable to have one LED light or LED fixture that can be installed into existing incandescent, compact fluorescent, or HID fixtures to ultimately create a longer lasting and energy efficient LED luminaire. The present invention provides for an LED light or LED fixture that allows an end user to have a retrofit LED lamp option to existing halogen, compact fluorescent, or HID luminaires. The same present invention also provides for an LED light or LED fixture option that allows an end user to readily install a new LED light or LED fixture as a recessed down light for new installations or as a recessed wall light.

The present invention will provide for a thermally efficient, very low profile, and high output LED light that can be installed in multiple applications including standalone surface mount as well as recessed down light installations where the space above a ceiling or behind a wall may have a very low space clearance.

In addition to the various advantages of the present invention, it is desirable for the LED light or LED fixture to have an integral trim formed as part of the die-cast housing to have the ability to easily present cosmetically different colors and finishes on the visible side of the trim as viewed from below the ceiling or at the wall and aesthetically match the furnishings or interior colors and finishes in the room where the LED light fixture is installed. Therefore, the present invention shall allow for the installation of interchangeable trim rings provided in different colors and finishes that can be mounted to the visible front interchangeable trim ring surface of the die-cast housing from below the ceiling and be securely held in place by magnets or other attachment means including glue, tape, Velcro, friction grips, tabs, clips and springs, etc. to prevent the front decorative interchangeable trim ring to accidently come apart away from the LED recessed light fixture.

### DESCRIPTION OF THE RELATED ART

Companies including Lighting Science Group and Commercial Electric for Home Depot among many others, offer LED recessed lights that can be use in existing fixtures as retrofits or as an LED fixture in new recessed down light installations. However, all of these models use external bulky and heavy heat sinks attached to a separate plate positioned at the rear of the fixtures to provide cooling for the LEDs. The additional heat sinks add extra and unnecessary weight, as well as added cost to the fixtures. The height of the heat sink in some fixtures also makes the LED recessed lights higher than necessary, thereby preventing its use in very low-profile ceiling or wall mount applications. Some background on a typical two-piece configuration for a recessed LED recessed light can be found in U.S. Pat. No. 8,201,968 issued to Maxik et al. titled, “Low profile light” and assigned to Lighting Science Group Corporation, and also in U.S. Pat. No. 8,672,518 issued to Boomgaarden et al. titled, “Low profile light and accessory kit for the same” that is also assigned to Lighting Science Group Corporation.

There are other patents that describe LED light fixtures installed as recessed down lights in a ceiling some of which are hereby disclosed for reference. U.S. Pat. No. 8,454,204 issued to Chang et al. titled, “Recessed LED lighting fixture” and assigned to Cordelia Lighting, Inc. includes the use of magnets to attach trim rings to the LED lighting fixture. U.S. Pat. No. 9,482,398 issued to Luk titled, “Lightweight and thermally efficient LED down light” and assigned to DeNovo Lighting, LLC. discloses a thermally efficient and lightweight LED light for both retrofit and junction box mounting. U.S. Pat. No. 9,557,021 issued to Madden et al. titled, “Recessed LED light fixture” and assigned to Cordelia Lighting, Inc. discloses an LED light assembly including a junction box mounted on top of a housing with driver inside and magnets for the attaching the trim. U.S. Pat. No. 9,964,266 issued to Danesh titled, “Unified driver and light source assembly for recessed lighting” and assigned to DMF, Inc. is for a down light with an internal driver and the use of a reflector part in all embodiments. Lastly, U.S. Pat. No. 10,119,684 issued to O'Brien et al. titled, “LED fixture and assembly” and assigned to Cordelia Lighting, Inc. discloses a light fixture connected onto a junction box only.

The present invention is an improvement over the other inventions. It uses a single unitary die-cast housing preferably made of aluminum or aluminum alloy for better thermal conductivity, which makes the overall LED fixture more lightweight. The die-cast housing can be made from different manufacturing processes including, but not limited to deep draw, stamping, spinning, metal forming, injection molding and other methods for making this multipurpose combination heat sink and integral trim assembly for the mounting of an LED board or LED arrays. This die-cast housing eliminates the need for having a separate interchangeable trim ring and heat sink, thereby reducing overall weight and cost of the LED light or LED fixture. Having a single piece also allows for better thermal conductivity of the LED board or LED arrays where heat from the LEDs is cooled directly by the die-cast housing into the interchangeable trim ring of the LED light or LED fixture without the need to go through multiple surfaces offering better and more efficient thermal transfer. In addition, the die-cast housing also serves as the means for mounting the entire LED light or LED fixture to a junction box for new installation applications, or the attachment of removable metal springs or clips and brackets for retrofit applications into existing lighting down light can fixtures.

The device of the present invention consists primarily of a die-cast housing. The main die-cast housing with integral flat flanged ring serves multiple purposes. Primarily, it serves as an immediate surface in which to mount an LED printed circuit board using discrete LEDs or a COB or chip-on-board LED fixture array. Secondarily, it serves as a thermally conductive heat sink. The circuit board contains at least one string of LEDs or LED arrays. Likewise, the COB may contain at least one string of LEDs or LED arrays. The third purpose is to serve as an integral base flat flanged ring for retrofit and new installation applications. Strong rare earth magnets may be used embedded into the integral flat flanged ring to attract and securely hold ferrous metal interchangeable trim ring covers in different colors and finishes for decorative use, or the metal interchangeable trim ring covers may have formable tabs to be bent over the outer lip of the integral base flat flanged ring.

Lastly, the main die-cast housing contains screw clearance holes for mounting to different size junction boxes for new installations, and also has provisions on it for the mounting of removable brackets, clips, and springs, or for the attachment of only springs provided for retrofitting the complete LED light assembly into an existing recessed down light can. Provisions are also provided on the main die-cast housing for the mounting of an LED light engine, an optional external driver, and a diffusion lens. The diffusion lens can be flush to the surface of the trim surface or it may be regressed into the main die-cast housing for anti-glare.

The preferred embodiment of the present invention consists of a main combination heat sink and integral flat flange ring metal unitary die-cast housing, screw passageway holes for direct mounting to a junction box, mounting supports for optional removable mounting clips or springs, LED light engine, diffusion lens, and an internal AC-to-DC dimmable LED driver. An alternate embodiment of the present invention consists of a main combination heat sink and integral flat flange ring metal die-cast housing, screw passageway holes for direct mounting to a junction box, mounting supports for optional removable mounting clips or springs, dimmable AC DOB driver-on-board LED light engine with internal controller, and a diffusion lens. No reflectors are required in both embodiments to save on cost and overall weight.

### SUMMARY OF THE INVENTION

The device of the present invention includes in its most basic form, a main die-cast housing with an integral flanged trim ring, junction box screw passageway holes, mounting supports for optional removable spring clips, an LED light engine, an LED driver, and a diffusion lens.

The preferred embodiment is therefore a dimmable device that has a combination heat sink and interchangeable trim ring main die-cast housing for mounting an LED circuit board or LED light engine to one side of the die-cast housing. The circuit board contains at least one string of LEDs or LED arrays. Likewise, the COB may contain at least one string of LEDs or LED arrays. Removable brackets containing springs or separate spring clips are attached to opposing sides of the die-cast housing for allowing the LED fixture to be installed into an existing down light can in a retrofit application. For new installations of the LED fixture mounted directly to a junction box, the removable brackets containing the springs or separate spring clips are not used. An integral AC-to-DC dimmable driver is mounted on the same side as the LED light engine or LED circuit board. This internal LED driver is then connected to the LED light engine consisting of at least one string of LEDs or LED arrays mounted to a circuit board, or to a chip-on-board (COB) LED array. Lastly, a separate diffusion lens made preferably out of glass or plastic is used to maintain an overall lower weight to the LED fixture and is attached to the main die-cast housing on the same side as the LED light engine to protect the LEDs from dust and damage and also to diffuse the light that is emitted out the front of the LEDs mounted to a circuit board.

The alternate embodiment is therefore a dimmable device that has a combination heat sink and interchangeable trim ring main die-cast housing for mounting a dimmable AC LED circuit board or dimmable AC LED light engine to one side of the die-cast housing. The circuit board contains at least one string of AC LEDs or AC LED arrays. Likewise, the AC COB may contain at least one string of LEDs or LED arrays. Removable brackets containing springs or separate spring clips are attached to the opposing sides of the die-cast housing for allowing the dimmable AC LED fixture to be installed into an existing down light can in a retrofit application. For new installations of the dimmable AC LED fixture mounted directly to a junction box, the removable brackets containing the springs or separate spring clips are not used. No remote driver is used with a dimmable AC LED circuit board. Instead, an on-board controller or ASIC or other means to power the LEDs including transistors or MOSFET devices may be used to operate the LEDs directly. The elimination of an internal LED driver removes added weight and cost, and provides for an overall lower profile LED light in general. Lastly, a separate diffusion lens made preferably out of glass or plastic is used to maintain an overall lower weight to the dimmable AC LED fixture and is attached to the main die-cast housing on the same side as the dimmable AC LED light engine to protect the dimmable AC LEDs from dust and damage and also to diffuse the light that is emitted out the front of the dimmable AC LEDs mounted to a circuit board.

### OBJECT OF THE INVENTION

It is an object of the present invention to provide a dimmable device that will work in a retrofit and in a new installation application.

It is another object of the present invention to provide a dimmable device that will fit into most existing down light can housings as a direct retrofit.

It is yet another object of the present invention to provide a dimmable device that can be installed into a wide variety of different junction boxes for new or existing installations.

It is also another object of the present invention to provide a dimmable device that will provide a very low-profile LED light option with a brighter light output than comparably thin LED down lights.

It is also yet another object of the present invention to provide a dimmable and high output LED light fixture for both retrofit and new installations with outputs of at least 900 lumens.

It is a final object of the invention to provide a dimmable device that will have a lower installed height profile for installation in tight overhead ceiling or wall installations.

While the novel features of the invention are set forth particularly in the appended claims, the invention, both as to organization and content will be better understood and appreciated along with other objects and features thereof, from the following detailed description taken in conjunction with the drawings.

### NUMERALS

10 LED LIGHT FIXTURE
20 TRIM RING
30 SPRING CLIPS
40 PIGTAIL CABLE
50 POWER CONNECTORS
60 MALE PLUG ADAPTER
70 CEILING LIGHT CAN
80 DIE-CAST HOUSING
90A FIRST SPRING CLIP
90B SECOND SPRING CLIP
100 LED PCB/COB LED/AC DOB LED MODULE
105 LED DRIVER OR AC DRIVER-ON-BOARD
110 AC POWER WIRES
120 PASSAGEWAY HOLE
130 DIFFUSION LENS
140 AC GROUNDING WIRE
150 HEAT SINK FINS
160 WIRES STRAP
170A FIRST WIRES STRAP MOUNTING SCREW
170B SECOND WIRES STRAP MOUNTING SCREW
180A FIRST CLIP SUPPORT POST
180B SECOND CLIP SUPPORT POST
190A FIRST CLIP MOUNTING SCREW
190B SECOND CLIP MOUNTING SCREW
200 LED LIGHT FIXTURE
210 JUNCTION BOX
220 TRIM RING
230 DIFFUSION LENS
240 INSTALLATION SCREWS
250A FIRST CLIP MOUNTING SUPPORT
250B SECOND CLIP MOUNTING SUPPORT
260 AC GROUNDING WIRE
270 AC POWER WIRES
280 DIE-CAST HOUSING
290 LED PCB/COB LED/AC DOB LED MODULE
300 LED DRIVER OR AC DOB
310 WIRES PASSAGEWAY HOLE
320 SOURCE OF INPUT POWER
330A FIRST MOUNTING SCREW HOLE
330B SECOND MOUNTING SCREW HOLE
340A FIRST INSTALLATION SCREW
340B SECOND INSTALLATION SCREW
350 HEAT SINK FINS
360 WIRES STRAP
370A FIRST WIRES STRAP MOUNTING SCREW
370B SECOND WIRES STRAP MOUNTING SCREW

### BRIEF DESCRIPTION OF THE DRAWINGS

FIG. 1 is an isometric view of the preferred embodiment of the present invention of a 4″ retrofit LED light fixture showing an installed decorative trim ring, diffusion lens, spring clips, power pigtail cable with quick disconnect power connectors, and an optional medium screw base male plug adapter for installation in a conventional 4″ ceiling light can.

FIG. 2 is a top view of the preferred embodiment of the present invention of the 4″ retrofit LED light fixture of FIG. 1 showing an installed decorative trim ring, diffusion lens, and spring clips for installation in a conventional ceiling light can.

FIG. 3 is a right view of the preferred embodiment of the present invention of the 4″ retrofit LED light fixture of FIG. 1 showing an installed decorative trim ring, spring clips, combination heat sink and integral flat flange ring unitary die-cast housing, power pigtail cable with quick disconnect power connectors, a fixture AC grounding wire, and an optional medium screw base male plug adapter for installation in a conventional 4″ ceiling light can.

FIG. 4 is a left view of the preferred embodiment of the present invention of the 4″ retrofit LED light fixture of FIG. 1 showing an installed decorative trim ring, spring clips, combination heat sink and integral flat flange ring unitary die-cast housing, power pigtail cable with quick disconnect power connectors, a fixture AC grounding wire, and an optional medium screw base male plug adapter for installation in a conventional 4″ ceiling light can.

FIG. 5 is a front view of the preferred embodiment of the present invention of the 4″ retrofit LED light fixture of FIG. 1 showing an installed decorative trim ring, spring clips, combination heat sink and integral flat flange ring unitary die-cast housing, power pigtail cable with quick disconnect power connectors, a fixture AC grounding wire, and an optional medium screw base male plug adapter for installation in a conventional 4″ ceiling light can.

FIG. 6 is a back view of the preferred embodiment of the present invention of the 4″ retrofit LED light fixture of FIG. 1 showing an installed decorative trim ring, spring clips, combination heat sink and integral flat flange ring unitary die-cast housing, power pigtail cable with quick disconnect power connectors, a fixture AC grounding wire, and an optional medium screw base male plug adapter for installation in a conventional 4″ ceiling light can.

FIG. 7 is a bottom view of the preferred embodiment of the present invention of the 4″ retrofit LED light fixture of FIG. 1 showing an installed decorative trim ring, spring clips, combination heat sink and integral flat flange ring unitary die-cast housing, power pigtail cable with quick disconnect power connectors, a fixture AC grounding wire, and an optional medium screw base male plug adapter for installation in a conventional 4″ ceiling light can.

FIG. 8 is an isometric view of the preferred embodiment of the present invention of a 4″ LED light fixture for direct mounting to a junction box showing an installed decorative trim ring, diffusion lens, junction box mounting screws, mounting supports for spring clips, and power pigtail wires cut and stripped for splice connections inside the junction box.

FIG. 9 is a top view of the preferred embodiment of the present invention of the 4″ LED light fixture of FIG. 8 for direct mounting to a junction box showing an installed decorative trim ring, and a diffusion lens.

FIG. 10 is a right view of the preferred embodiment of the present invention of the 4″ LED light fixture of FIG. 8 for direct mounting to a junction box showing an installed decorative trim ring, combination heat sink and integral flat flange ring unitary die-cast housing, an AC grounding wire, junction box mounting screws, mounting supports for spring clips (not shown), and power pigtail wires cut and stripped for direct wire splicing inside the junction box.

FIG. 11 is a left view of the preferred embodiment of the present invention of the 4″ LED light fixture of FIG. 8 for direct mounting to a junction box showing an installed decorative trim ring, combination heat sink and integral flat flange ring unitary die-cast housing, an AC grounding wire, junction box mounting screws, mounting supports for spring clips (not shown), and power pigtail wires cut and stripped for direct wire splicing inside the junction box.

FIG. 12 is a front view of the preferred embodiment of the present invention of the 4″ LED light fixture of FIG. 8 for direct mounting to a junction box showing an installed decorative trim ring, combination heat sink and integral flat flange ring unitary die-cast housing, an AC grounding wire, junction box mounting screws, mounting supports for spring clips (not shown), and power pigtail wires cut and stripped for direct wire splicing inside the junction box.

FIG. 13 is a back view of the preferred embodiment of the present invention of the 4″ LED light fixture of FIG. 8 for direct mounting to a junction box showing an installed decorative trim ring, combination heat sink and integral flat flange ring unitary die-cast housing, an AC grounding wire, junction box mounting screws, mounting supports for spring clips (not shown), and power pigtail wires cut and stripped for direct wire splicing inside the junction box.

FIG. 14 is a bottom view of the preferred embodiment of the present invention of the 4″ LED light fixture of FIG. 8 for direct mounting to a junction box showing an installed decorative trim ring, combination heat sink and integral flat flange ring unitary die-cast housing, an AC grounding wire, junction box mounting screws, mounting supports for spring clips (not shown), and power pigtail wires cut and stripped for direct wire splicing inside the junction box.

The foregoing has outlined rather broadly, the features and technical advantages of the present invention, so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

### DETAILED DESCRIPTION

Although the present invention has been described in terms of the presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

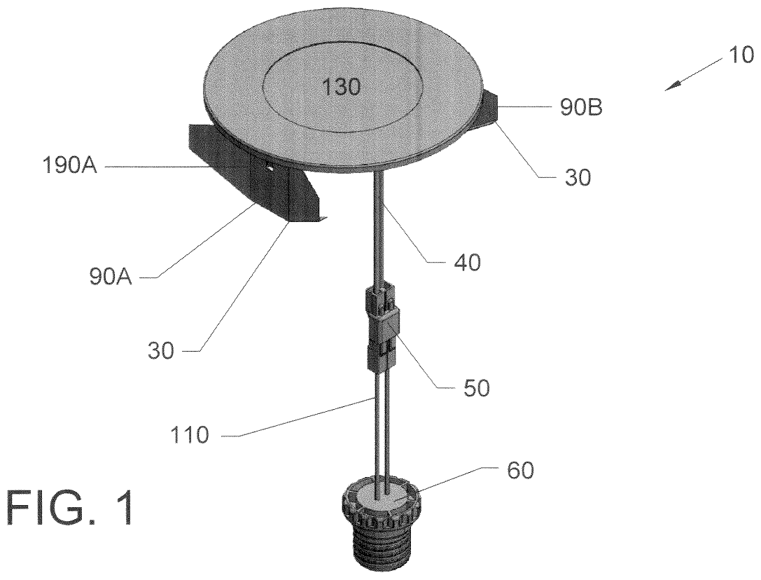

FIG. 1 is an isometric view of the preferred embodiment of the present invention of a 4″ retrofit LED light fixture 10 showing an installed decorative trim ring 20, diffusion lens 130, spring clips 30, power pigtail cable 40 with mating quick disconnect power connectors 50, and an optional medium screw base male plug adapter 60 for installation in a conventional 4″ ceiling light can 70 (not shown). LED light fixture 10 consists of a main die-cast housing 80 with two mounting spring clips 30 centered around the periphery of die-cast housing 80. First spring clip 90A and second spring clip 90B are preferably made of spring steel material and fastened to the outside of die-cast housing 80. An LED circuit board or COB LED or AC dob LED module 100 (not shown) with internal dimmable LED driver or AC driver-on-board 105 is attached to the opposite inside of die-cast housing 80. AC power wires 110 (not shown) from internal dimmable LED driver or AC driver-on-board 105 (not shown) are fed through a clearance passageway hole 120 to the back outside of die-cast housing 80 for connection to a pair of mating disconnect power connectors 50 attached to a medium screw base male plug adapter 60. Lastly, diffusion lens 130 is attached to the front of die-cast housing 80 to cover and protect LED circuit board or COB LED or AC dob LED module 100 (not shown) and internal dimmable LED driver or AC driver-on-board 105 from dust and damage, and also provides the proper optics to effectively output a bright and even diffused light from LED light fixture 10.

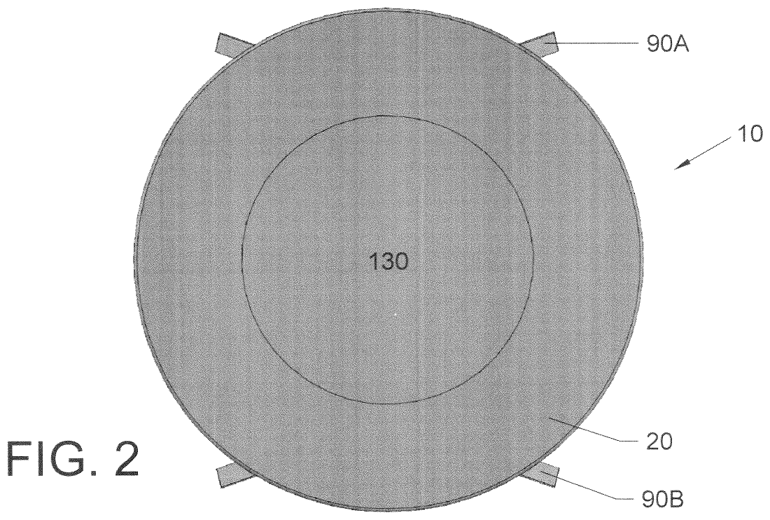

FIG. 2 is a top view of the preferred embodiment of the present invention of the 4″ retrofit LED light fixture 10 of FIG. 1 showing an installed decorative trim ring 20, diffusion lens 130, and first spring clip 90A and second spring clip 90B for installation in a conventional ceiling light can 70 (not shown).

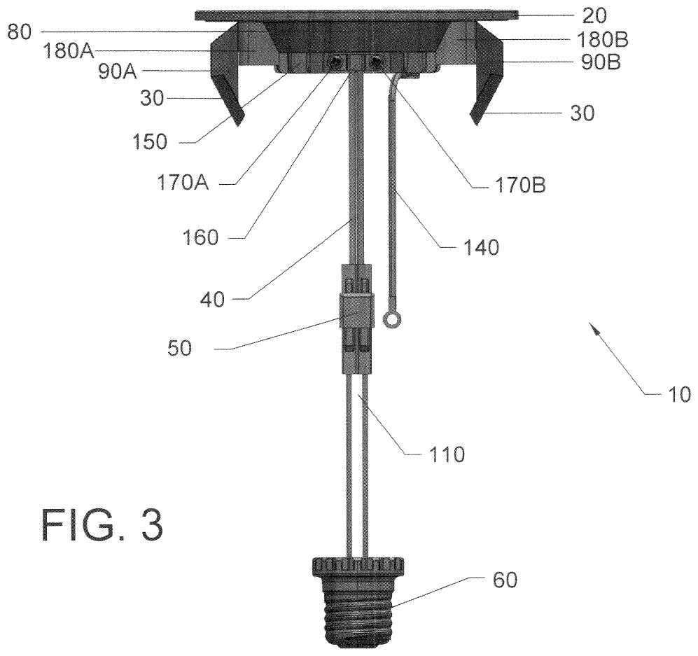

FIG. 3 is a right view of the preferred embodiment of the present invention of the 4″ retrofit LED light fixture 10 of FIG. 1 showing an installed decorative trim ring 20, spring clips 30, combination heat sink and integral flat flange ring unitary main die-cast housing 80, power pigtail cable 40 with quick mating disconnect power connectors 50, a fixture AC grounding wire 140, and an optional medium screw base male plug adapter 60 for installation in a conventional 4″ ceiling light can 70 (not shown). LED light fixture 10 consists of a main die-cast housing 80 with first spring clip 90A and second spring clip 90B centered around the periphery of die-cast housing 80. Spring clips 30 are preferably made of spring steel material and fastened to die-cast housing 80. Heat sink fins 150 are visible on the outside of main die-cast housing 80 also centered around the periphery of die-cast housing 80. An LED circuit board or COB LED or AC dob LED module 100 (not shown) with internal dimmable LED driver or AC driver-on-board 105 (not shown) is attached to the inside of die-cast housing 80. AC power wires 110 from internal dimmable LED driver or AC driver-on-board 105 (not shown) are fed through a clearance passageway hole 120 to the back outside of die-cast housing 80 for connection to a pair of mating disconnect power connectors 50 attached to a medium screw base male plug adapter 60. Strain relief wires strap 160 held by first wires strap mounting screw 170A and second wires strap mounting screw 170B to main die-cast housing 80 prevents AC power wires 110 from being pulled out of die-cast housing 80. An AC grounding wire 140 is provided for the safe and proper ground bonding of the LED light fixture 10. Decorative trim ring 20 is installed to the front of LED light fixture 10. Lastly, diffusion lens 130 (not shown) is attached to the front of die-cast housing 80 to cover and protect LED circuit board or COB LED or AC dob LED module 100 (not shown) and LED driver or AC driver-on-board 105 (not shown) from dust and damage, and also provides the proper optics to effectively output a bright and even diffused light from LED light fixture 10.

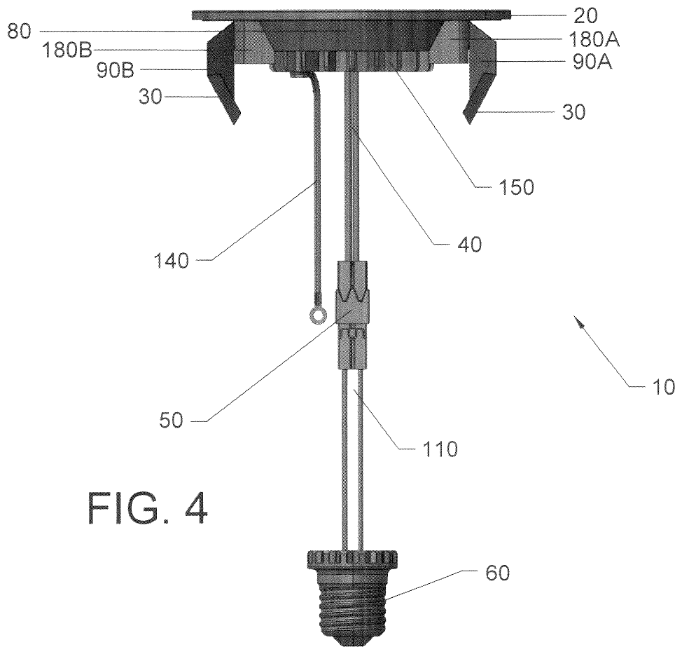

FIG. 4 is a left view of the preferred embodiment of the present invention of the 4″ retrofit LED light fixture 10 of FIG. 1 showing an installed decorative trim ring 20, spring clips 30, combination heat sink and integral flat flange ring unitary main die-cast housing 80, power pigtail cable 40 with mating quick disconnect power connectors 50, a fixture AC grounding wire 140, and an optional medium screw base male plug adapter 60 for installation in a conventional 4″ ceiling light can 70 (not shown). LED light fixture 10 consists of a main die-cast housing 80 with first spring clip 90A and second spring clip 90B centered around the periphery of die-cast housing 80. Spring clips 30 are preferably made of spring steel material and fastened to die-cast housing 80. Heat sink fins 150 are visible on the outside of main die-cast housing 80 also centered around the periphery of die-cast housing 80. An LED circuit board or COB LED or AC dob LED module 100 (not shown) with LED driver or AC driver-on-board 105 (not shown) is attached to the inside of die-cast housing 80. AC power wires 110 from internal dimmable LED driver or AC driver-on-board 105 (not shown) are fed through a clearance passageway hole 120 to the back outside of die-cast housing 80 for connection to a pair of mating quick disconnect power connectors 50 attached to a medium screw base male plug adapter 60. An AC grounding wire 140 is provided for the safe and proper ground bonding of the LED light fixture 10. Decorative trim ring 20 is installed to the front of LED light fixture 10. Lastly, diffusion lens 130 (not shown) is attached to the front of die-cast housing 80 to cover and protect LED circuit board or COB LED or AC dob LED module 100 (not shown) and internal dimmable LED driver or AC driver-on-board 105 from dust and damage, and also provides the proper optics to effectively output a bright and even diffused light from LED light fixture.

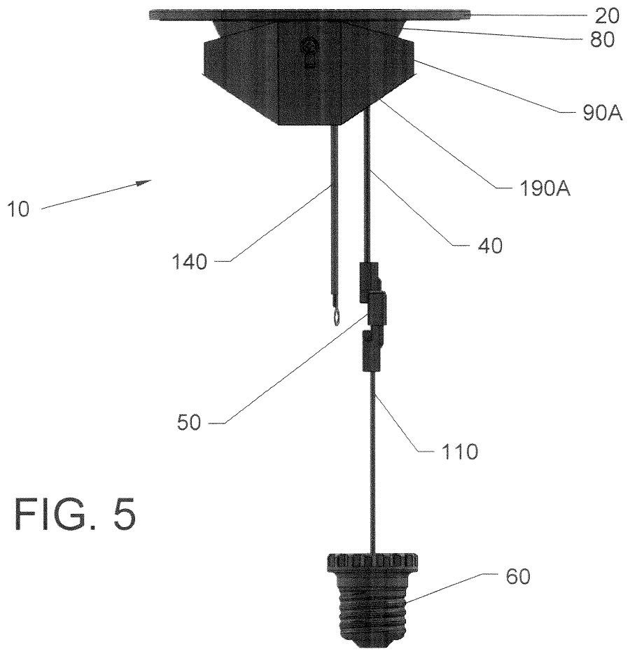

FIG. 5 is a front view of the preferred embodiment of the present invention of the 4″ retrofit LED light fixture 10 of FIG. 1 showing an installed decorative trim ring 20, spring clips 30, combination heat sink and integral flat flange ring unitary main die-cast housing 80, power pigtail cable 40 with mating quick disconnect power connectors 50, a fixture AC grounding wire 140, and an optional medium screw base male plug adapter 60 for installation in a conventional 4″ ceiling light can 70 (not shown). LED light fixture 10 consists of a main die-cast housing 80 with mounting spring clips 30 centered around the periphery of die-cast housing 80. Spring clips 30 are preferably made of spring steel material and fastened to die-cast housing 80 to threaded first clip support post 180A and second clip support post 180B that are part of the die-cast housing 80 by first clip mounting screw 190A and second clip mounting screw 190B respectively. Heat sink fins 150 are visible on the outside of main die-cast housing 80 also centered around the periphery of die-cast housing 80. An LED circuit board or COB LED or AC dob LED module 100 (not shown) is attached to the inside of die-cast housing 80. AC power wires 110 from internal dimmable LED driver or AC driver-on-board 105 (not shown) are fed through a clearance passageway hole 120 to the back outside of die-cast housing 80 for connection to a pair of mating power connectors 50 attached to a medium screw base male plug adapter 60. An AC grounding wire 140 is provided for the safe and proper ground bonding of the LED light fixture 10. Decorative trim ring 20 is installed to the front of LED light fixture 10. Lastly, diffusion lens 130 (not shown) is attached to the front of die-cast housing 80 to cover and protect LED circuit board or COB LED or AC dob LED module 100 (not shown) from dust and damage, and also provides the proper optics to effectively output a bright and even diffused light from LED light fixture 10.

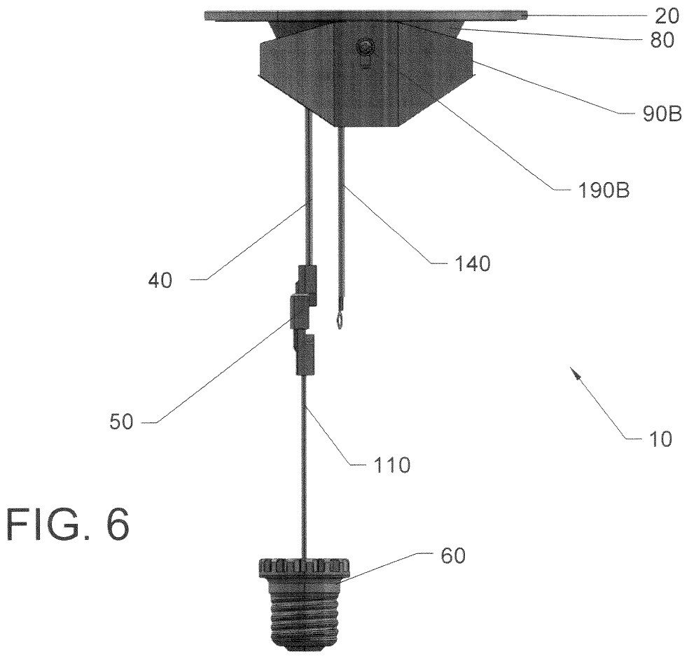

FIG. 6 is a back view of the preferred embodiment of the present invention of the 4″ retrofit LED light fixture 10 of FIG. 1 showing an installed decorative trim ring 20, spring clips 30, combination heat sink and integral flat flange ring unitary main die-cast housing 80, power pigtail cable 40 with mating quick disconnect power connectors 50, a fixture AC grounding wire 140, and an optional medium screw base male plug adapter 60 for installation in a conventional 4″ ceiling light can 70 (not shown). LED light fixture 10 consists of a main die-cast housing 80 with mounting spring clips 30 centered around the periphery of die-cast housing 80. Spring clips 30 are preferably made of spring steel material and fastened to die-cast housing 80 to threaded clips mounting support posts 180 that are part of the die-cast housing 80 by first clip mounting screw 190A and second clip mounting screw 190B. Heat sink fins 150 are visible on the outside of main die-cast housing 80 also centered around the periphery of die-cast housing 80. An LED circuit board or COB LED or AC dob LED module 100 (not shown) is attached to the inside of die-cast housing 80. AC power wires 110 from internal dimmable LED driver or AC driver-on-board 105 (not shown) to LED circuit board or COB LED or AC dob LED module 100 are fed through a clearance passageway hole 120 out the back of die-cast housing 80 for connection to a pair of mating power connectors 50 attached to a medium screw base male plug adapter 60. An AC grounding wire 140 is provided for the safe and proper ground bonding of the LED light fixture 10. Decorative trim ring 20 is installed to the front of LED light fixture 10. Lastly, diffusion lens 130 (not shown) is attached to the front of die-cast housing 80 to cover and protect LED circuit board or COB LED or AC dob LED module 100 (not shown) from dust and damage, and also provides the proper optics to effectively output a bright and even diffused light from LED light fixture 10.

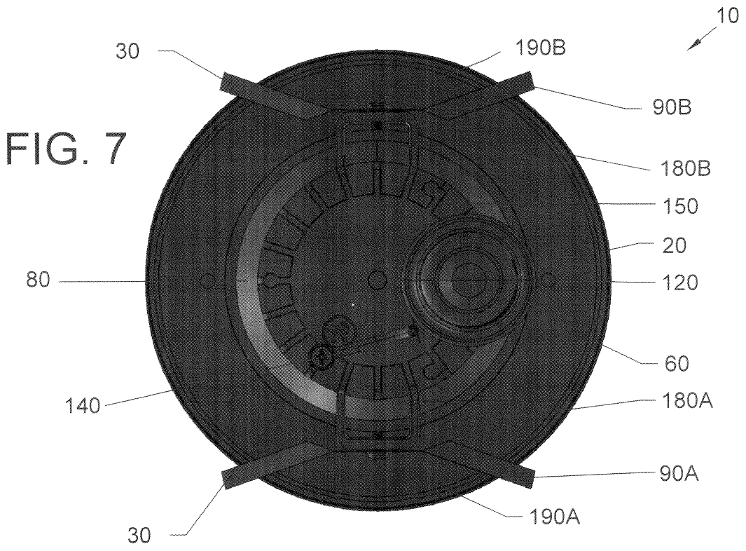

FIG. 7 is a bottom view of the preferred embodiment of the present invention of the 4″ retrofit LED light fixture of FIG. 1 showing an installed decorative trim ring 20, spring clips 30, combination heat sink and integral flat flange ring unitary main die-cast housing 80, power pigtail cable 40 with quick disconnect power connectors 50, a fixture AC grounding wire 140, and an optional medium screw base male plug adapter 60 for installation in a conventional 4″ ceiling light can 70 (not shown). LED light fixture 10 consists of a main die-cast housing 80 with first spring mounting clip 90A and second spring mounting clip 90B centered around the periphery of die-cast housing 80. Spring clips 30 are preferably made of spring steel material and fastened to die-cast housing 80 to threaded clips mounting support posts 180 that are part of the die-cast housing 80 by first clip mounting screw 190A and second clip mounting screw 190B. Heat sink fins 150 are visible on the outside of main die-cast housing 80 also centered around the periphery of die-cast housing 80. An LED circuit board or COB LED or AC dob LED module 100 (not shown) is attached to the inside of die-cast housing 80. AC power wires 110 from internal dimmable LED driver or AC driver-on-board 105 (not shown) to LED circuit board or COB LED or AC dob LED module 100 are fed through a clearance passageway hole 120 out the back of die-cast housing 80 for connection to a pair of mating power connectors 50 attached to a medium screw base male plug adapter 60. An AC grounding wire 140 is provided for the safe and proper ground bonding of the LED light fixture 10. Decorative trim ring 20 is installed to the front of LED light fixture 10. Lastly, diffusion lens 130 (not shown) is attached to the front of die-cast housing 80 to cover and protect LED circuit board or COB LED or AC dob LED module 100 (not shown) from dust and damage, and also provides the proper optics to effectively output a bright and even diffused light from LED light fixture 10.

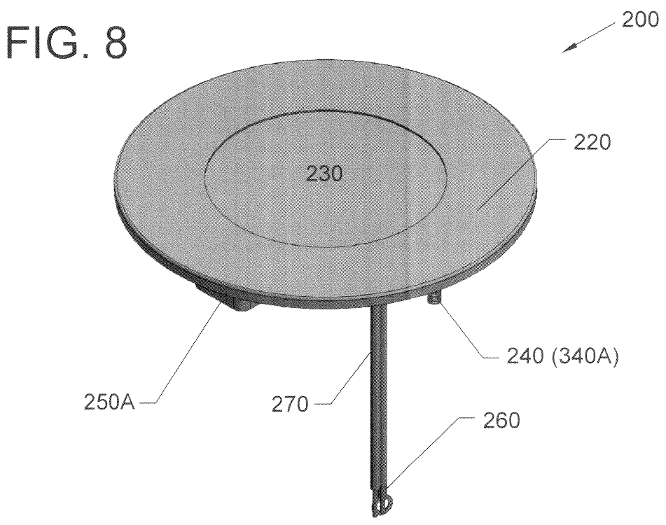

FIG. 8 is an isometric view of the preferred embodiment of the present invention of a 4″ LED light fixture 200 for direct mounting to a junction box 210 (not shown) showing an installed decorative trim ring 220, diffusion lens 230, junction box installation screws 240, spring clips mounting supports 250, an AC grounding wire 260, and pigtail AC power wires 270 cut and stripped for splice connections inside the junction box (not shown). LED light fixture 200 consists of a main die-cast housing 280 including an LED circuit board or COB LED or AC dob LED module 290 (not shown) mounted inside main die-cast housing 280. Pigtail AC power wires 270 from internal dimmable LED driver or AC driver-on-board 300 (not shown) are fed through a clearance wires passageway hole 310 out the back of die-cast housing 280 for connection to a source of input power 320 (not shown). First mounting screw hole 330A and second mounting screw hole 330B, for first installation screw 340A and second installation screw 340B respectively, are all provided on die-cast housing 280 for attaching LED light fixture 200 to a standard junction box 210 (not shown). An AC grounding wire 260 is provided for the safe and proper ground bonding of the LED light fixture 200. Decorative trim ring 220 is installed to the front of LED light fixture 200. Lastly, diffusion lens 230 is attached to the front of die-cast housing 280 to cover and protect LED circuit board or COB LED or AC dob LED module 290 (not shown) from dust and damage, and also provides the proper optics to effectively output a bright and even diffused light from LED light fixture 200.

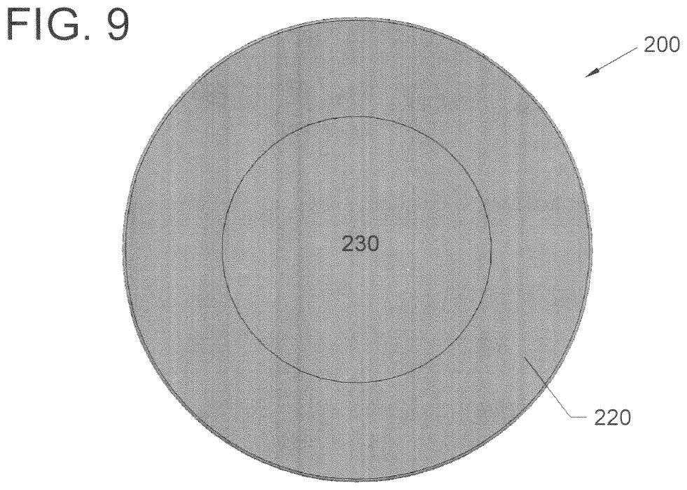

FIG. 9 is a top view of the preferred embodiment of the present invention of the 4″ LED light fixture 200 of FIG. 8 for direct mounting to a junction box 210 (not shown) displaying an installed decorative trim ring 220 and a diffusion lens 230.

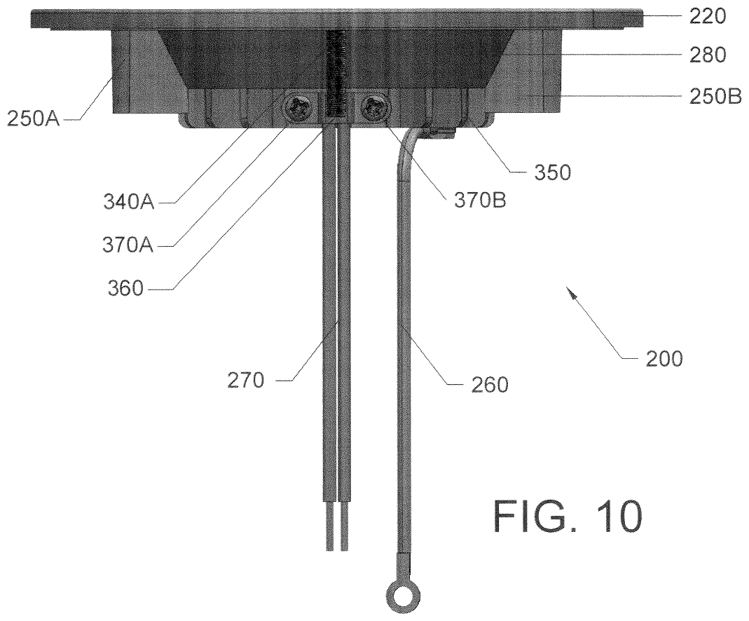

FIG. 10 is a right view of the preferred embodiment of the present invention of the 4″ LED light fixture 200 of FIG. 8 for direct mounting to a junction box 210 (not shown) displaying an installed decorative trim ring 220, combination heat sink and integral flat flange ring unitary main die-cast housing 280, an AC grounding wire 260, junction box mounting screws 330, spring clips mounting supports 250 (not shown), and pigtail AC power wires 270 cut and stripped for direct wire splicing inside the junction box 210 (not shown). LED light fixture 200 consists of a main die-cast housing 280 including an LED circuit board or COB LED or AC dob LED module 290 (not shown) mounted inside main die-cast housing 280 with visible heat sink fins 350 arranged on the outside of main die-cast housing 280 and centered around the periphery of die-cast housing 280. Pigtail AC power wires 270 from an internal dimmable LED driver or AC driver-on-board 300 (not shown) are fed through a clearance wires passageway hole 310 out the back of die-cast housing 280 for connection to a source of input power 320 (not shown). Strain relief wires strap 360 is held by first wires strap mounting screw 370A and second wires strap mounting screw 370B to main die-cast housing 280 to prevent pigtail AC power wires 270 from being pulled out of die-cast housing 280. An AC grounding wire 260 is provided for the safe and proper ground bonding of the LED light fixture 200. Junction box mounting screw clearance holes 330 and installation screws 340A, 340B are provided on die-cast housing 280 for attaching LED light fixture 200 to a standard junction box 210 (not shown). Decorative trim ring 220 is installed to the front of LED light fixture 200. Lastly, diffusion lens 230 (not shown) is attached to the front of die-cast housing 280 to cover and protect LED circuit board or COB LED or AC dob LED module 290 (not shown) from dust and damage, and also provides the proper optics to effectively output a bright and even diffused light from LED light fixture 200.

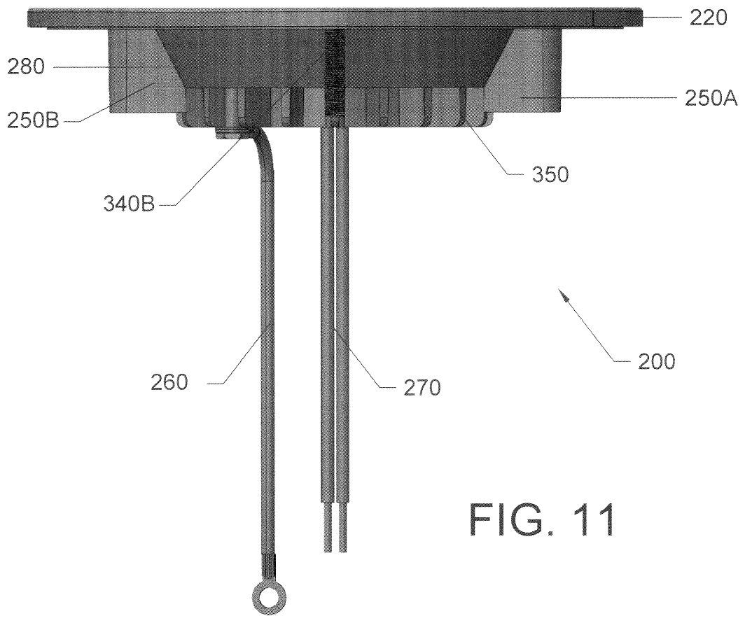

FIG. 11 is a left view of the preferred embodiment of the present invention of the 4″ LED light fixture 200 of FIG. 8 for direct mounting to a junction box 210 (not shown) displaying an installed decorative trim ring 220, combination heat sink and integral flat flange ring unitary main die-cast housing 280, an AC grounding wire 260, junction box mounting screws 330, spring clips mounting supports 250 (not shown), and pigtail AC power wires 270 cut and stripped for direct wire splicing inside the junction box 210 (not shown). LED light fixture 200 consists of a main die-cast housing 280 including an LED circuit board or COB LED or AC dob LED module 290 (not shown) mounted inside main die-cast housing 280 with visible heat sink fins 350 arranged on the outside of main die-cast housing 280 and centered around the periphery of die-cast housing 280. Pigtail AC power wires 270 from an internal dimmable LED driver or AC driver-on-board 300 (not shown) are fed through a clearance wires passageway hole 310 out the back of die-cast housing 280 for connection to a source of input power 320 (not shown). An AC grounding wire 260 is provided for the safe and proper ground bonding of the LED light fixture 200. Junction box 210 (not shown) clearance mounting screw holes 330 and installation screws 340A, 340B are provided on die-cast housing 280 for attaching LED light fixture 200 to a standard junction box 210 (not shown). Decorative trim ring 220 is installed to the front of LED light fixture 200. Lastly, diffusion lens 230 (not shown) is attached to the front of die-cast housing 280 to cover and protect LED circuit board or COB LED or AC dob LED module 290 (not shown) from dust and damage, and also provides the proper optics to effectively output a bright and even diffused light from LED light fixture 200.

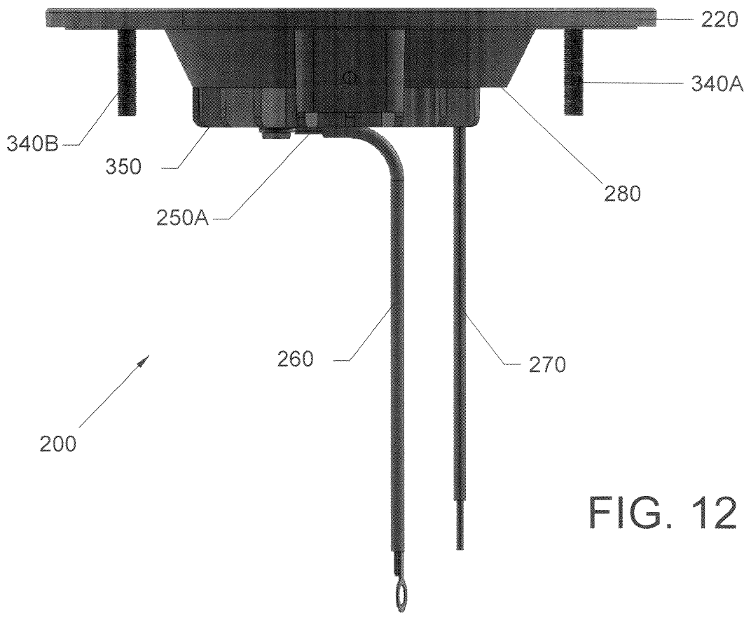

FIG. 12 is a front view of the preferred embodiment of the present invention of the 4″ LED light fixture 200 of FIG. 8 for direct mounting to a junction box 210 (not shown) displaying an installed decorative trim ring 220, combination heat sink and integral flat flange ring unitary main die-cast housing 280, an AC grounding wire 260, junction box installation screws 240, spring clips mounting supports 250 (not shown), and pigtail AC power wires 270 cut and stripped for direct wire splicing inside the junction box 210 (not shown). LED light fixture 200 consists of a main die-cast housing 280 including an LED circuit board or COB LED or AC dob LED module 290 (not shown) mounted inside main die-cast housing 280 with visible heat sink fins 350 arranged on the outside of main die-cast housing 280 and centered around the periphery of die-cast housing 280. AC power wires 270 from an internal dimmable LED driver or AC driver-on-board 300 (not shown) are fed through a clearance wires passageway hole 310 out the back of die-cast housing 280 for connection to a source of input power 320 (not shown). An AC grounding wire 260 is provided for the safe and proper ground bonding of the LED light fixture 200. Junction box 210 (not shown) clearance mounting screw holes 330 and installation screws 340A, 340B are provided on die-cast housing 280 for attaching LED light fixture 200 to a standard junction box 210 (not shown). Decorative trim ring 220 is installed to the front of LED light fixture 200. Lastly, diffusion lens 230 (not shown) is attached to the front of die-cast housing 280 to cover and protect LED circuit board or COB LED or AC dob LED module 290 (not shown) from dust and damage, and also provides the proper optics to effectively output a bright and even diffused light from LED light fixture 200.

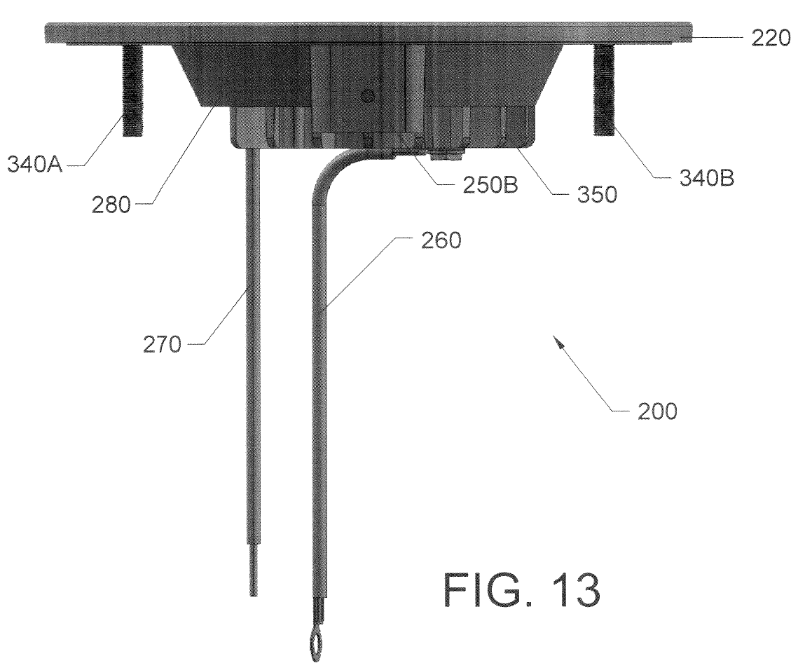

FIG. 13 is a back view of the preferred embodiment of the present invention of the 4″ LED light fixture 200 of FIG. 8 for direct mounting to a junction box 210 (not shown) displaying an installed decorative trim ring 220, combination heat sink and integral flat flange ring unitary main die-cast housing 280, an AC grounding wire 260, junction box installation screws 240, spring clips mounting supports 250 (not shown), and AC power wires 270 cut and stripped for direct wire splicing inside the junction box 210 (not shown). LED light fixture 200 consists of a main die-cast housing 280 including an LED circuit board or COB LED or AC dob LED module 290 (not shown) mounted inside main die-cast housing 280 with visible heat sink fins 350 arranged on the outside of main die-cast housing 280 and centered around the periphery of die-cast housing 280. AC power wires 270 from internal dimmable LED driver or AC driver-on-board 300 (not shown) are fed through a clearance wires passageway hole 310 out the back of die-cast housing 280 for connection to a source of input power 320 (not shown). An AC grounding wire 260 is provided for the safe and proper ground bonding of the LED light fixture 200. Junction box 210 (not shown) clearance mounting screw holes 330 and installation screws 340A, 340B are provided on die-cast housing 280 for attaching LED light fixture 200 to a standard junction box 210 (not shown). Decorative trim ring 220 is installed to the front of LED light fixture 200. Lastly, diffusion lens 230 (not shown) is attached to the front of die-cast housing 280 to cover and protect LED circuit board or COB LED or AC dob LED module 290 (not shown) from dust and damage, and also provides the proper optics to effectively output a bright and even diffused light from LED light fixture 200.

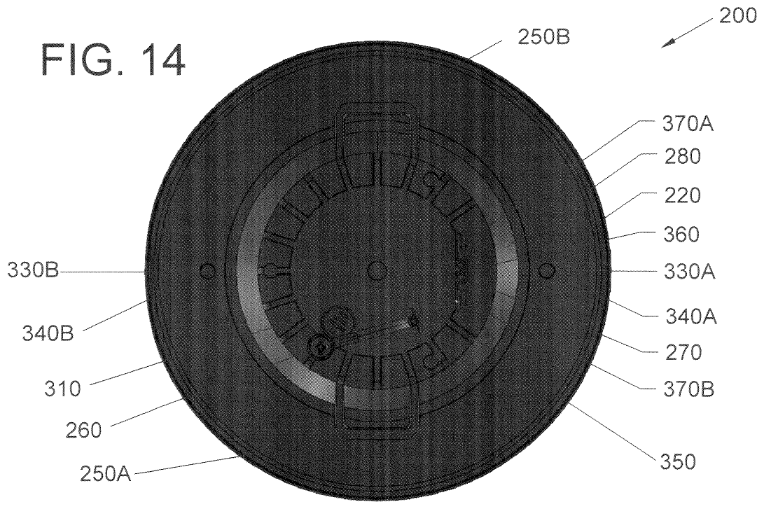

FIG. 14 is a bottom view of the preferred embodiment of the present invention of the 4″ LED light fixture 200 of FIG. 8 for direct mounting to a junction box 210 (not shown) displaying an installed decorative trim ring 220, combination heat sink and integral flat flange ring unitary main die-cast housing 280, an AC grounding wire 260, junction box installation screws 240, first clip mounting support 250A, second clip mounting support 250B, and pigtail AC power wires 270 cut and stripped for direct wire splicing inside the junction box 210 (not shown). LED light fixture 200 consists of a main die-cast housing 280 including an LED circuit board or COB LED or AC dob LED module 290 (not shown) mounted inside main die-cast housing 280 with visible heat sink fins 350 arranged on the outside of main die-cast housing 280 and centered around the periphery of die-cast housing 280. AC power wires 270 from internal dimmable LED driver or AC driver-on-board 300 (not shown) are fed through a clearance wires passageway hole 310 out the back of die-cast housing 280 for connection to a source of input power 320 (not shown). An AC grounding wire 260 is provided for the safe and proper ground bonding of the LED light fixture 200. Clearance mounting screw holes 330 and installation screws 340A, 340B are provided on die-cast housing 280 for attaching LED light fixture 200 to a standard junction box 210 (not shown). Decorative trim ring 220 is installed to the front of LED light fixture 200. Lastly, diffusion lens 230 (not shown) is attached to the front of die-cast housing 280 to cover and protect LED circuit board or COB LED or AC dob LED module 290 (not shown) from dust and damage, and also provides the proper optics to effectively output a bright and even diffused light from LED light fixture 200.

It will be understood that various changes in the details, materials, types, values, and arrangements of the components that have been described and illustrated in order to explain the nature of this invention may be made by those skilled in the art without departing from the principle and scope of the invention as expressed in the following claims.

What is claimed is:

1. An LED light fixture for a recessed down light can including:
at least one LED array mounted to a circuit board, a combination heat sink and integral flat flange ring unitary main die-cast housing for attaching said at least one LED array mounted to a circuit board,
removable trim ring covers for the flat flange ring in said unitary main die-cast housing,
at least two removable springs positioned on the periphery of said die-cast housing for retrofitting said LED light fixture to said recessed down light can,
a medium screw base male plug adapter, and
a diffusion lens mounted over said at least one LED array mounted to a circuit board in said LED light fixture.

2. An LED light fixture for a recessed down light can according to claim 1 further including:
an internal dimmable LED driver or AC driver-on-board connected to said at least one LED array mounted to a circuit board.

3. An LED light fixture for a recessed down light can according to claim 1 wherein:
said combination heat sink and integral flat flange ring unitary main die-cast housing for attaching said at least one LED array mounted to a circuit board has,
an overall height dimension of at least 1″,
an overall flange diameter dimension of at least 4″, and
at least 900 lumens of luminous flux light output emanating from said LED light fixture.

4. An LED light fixture for installation to a junction box including:
at least one LED array mounted to a circuit board, a combination heat sink and integral flat flange ring unitary main die-cast housing for attaching said at least one LED array mounted to a circuit board,
removable trim ring covers for the flat flange ring in said unitary main die-cast housing,
at least two screw clearance holes provided on said die-cast housing for mounting said LED light fixture to a junction box,
an internal dimmable LED driver or AC driver-on-board connected to said at least one LED array mounted to a circuit board, and
a diffusion lens mounted over said at least one LED array mounted to a circuit board in said LED light fixture.

5. An LED light fixture for installation to a junction box according to claim 4 wherein:
said combination heat sink and integral flat flange ring unitary main die-cast housing for attaching said at least one LED array mounted to a circuit board has,
an overall height dimension of at least 1″,
an overall flange diameter dimension of at least 4″, and
at least 900 lumens of luminous flux light output emanating from said LED light fixture.

6. A dual-purpose LED light fixture for installation to a junction box and alternate installation in a recessed down light can including:
at least one LED array mounted to a circuit board,
a combination heat sink and integral flat flange ring unitary main die-cast housing for attaching said at least one LED array mounted to a circuit board,
removable trim ring covers for the flat flange ring in said unitary main die-cast housing,
an internal dimmable LED driver or AC driver-on-board connected to said at least one LED array mounted to a circuit board,
at least two screw clearance holes provided on said die-cast housing for mounting said LED light fixture to a junction box,
at least two spring clip mounting supports positioned on the periphery of said die-cast housing for at least two spring clips,
at least two removable spring clips,
a removable pair of mating quick disconnect power connectors,
a removable medium screw base male plug adapter, and
a diffusion lens mounted over said at least one LED array mounted to a circuit board in said LED light fixture.

7. A dual-purpose LED light fixture for installation to a junction box and alternate installation in a recessed down light can according to claim 6 wherein:
said combination heat sink and integral flat flange ring unitary main die-cast housing for attaching said at least one LED array mounted to a circuit board has,
an overall height dimension of at least 1″,
an overall flange diameter dimension of at least 4″, and
at least 900 lumens of luminous flux light output emanating from said LED light fixture.
